(19) United States
(12) Patent Application Publication
(10) Pub. No.: US 2008/0176564 A1
(43) Pub. Date: Jul. 24, 2008

(54) Apparatus, method and computer program product providing inter-rat measurement control based on connection data rate

(75) Inventor: Lauri Eerolainen, Salo (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/656,175

(22) Filed: Jan. 22, 2007

(51) Int. Cl. H04Q 7/20

(52) U.S. Cl. 455/436

(57) ABSTRACT

A method, computer program product and a wireless network node operate to determine in a wireless communication network a current communication requirement of a user equipment that is communicating using a first type of radio access technology; and to instruct the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology. A user equipment that operates accordingly is also disclosed.

### TECHNICAL FIELD

The exemplary and non-limiting embodiments of this invention relate generally to wireless communication systems, methods, devices and computer program products and, more specifically, relate to techniques to provide inter-radio access technology operation of a user equipment.

### BACKGROUND

Various abbreviations that appear in the specification and/or in the drawing figures are defined as follows:

2G 2nd generation mobile communication system, for example GSM

3G 3rd generation mobile communication system, for example WCDMA

3.9G advanced 3rd generation communication system, for example EUTRAN

BA BCCH allocation

BCCH broadcast control channel

BSIC base transceiver station identity code

CN core network

DL downlink

EDGE enhanced data rates for GSM evolution

EUTRAN evolved universal terrestrial radio access network

FDD frequency division duplex

GPRS general packet radio service

GSM global system for mobile communications

HO handover

LTE long term evolution

Node-B base station

eNB evolved Node-B

MS mobile station

NW network

RAT radio access technology

SACCH slow associated control channel

SDCCH stand-alone dedicated control channel

TCH traffic channel

TDD time division duplex

UE user equipment

UL uplink

UMTS universal mobile telephony standard

UTRAN universal terrestrial radio access network

WCDMA wideband code division multiple access

PS packet scheduler

MRHC measurement report handling and control

QoS quality of service

It may be anticipated that future mobile phones (which may be collectively referred to as MSs and/or UEs or simply as UEs) will support several RATs (e.g. 2G/3G/3.9G). In order to provide seamless service to the UE in a case where it moves outside of the coverage of a current “camped on”/active RAT, measurement reports need to be sent to the NW. In response to the measurement reports the NW may order the UE to make a HO to a better cell, or possibly to operate with a different RAT.

As an example, assume that the UE begins a phone call in a 3G NW, and that the UE is moving outside of the 3G network radio coverage area. The NW will detect this condition from the measurement reports received from the UE and may command the UE to change the active RAT from 3G to 2G. After the change-over the phone call continues, ideally providing seamless service to the user.

A problem that arises in this scenario is that in the future it can be expected that (user) data rates for a single active connection can vary widely from a very low data rate (e.g., an ordinary phone call) to very high (e.g., receiving a TV broadcast). However, UE operation at a high data rate implies that there is less time available to make the necessary inter-RAT measurements (at least in a UE having a single receiver) to provide mobility and seamless service.

This problem is thus two dimensional, as higher (user) data rates per connection means that less time is available for inter-RAT measurements (at least in a single receiver UE), while as time progresses it can be expected that there will be more RATs to be measured.

Currently the inter-RAT measurements are handled as specified in 3GPP specifications. For example, when the UE is camped on a 2G network the inter-RAT handover measurements are defined in 3GPP TS 45.008, V7.6.0 (2006-11), 3rd Generation Partnership Project; Technical Specification Group GSM/EDGE Radio Access Network; Radio subsystem link control (Release 7), in subclause 7.3. According to this particular specification the inter-RAT measurements are controlled by different threshold parameters and a neighbor list (a list of neighboring base stations).

More specifically, subclause 7.3 “Handover measurements on other radio access technologies” states that for a multi-RAT MS, the network controls the identification and measurements of cells belonging to other radio access technologies by a parameter Qsearch_C sent on the SACCH or, if Qsearch_C is not received, by Qsearch_C_Initial sent on the BCCH. Qsearch_C defines a threshold and also indicates whether these tasks shall be performed when RXLEV (see subclause 8.1.3) of the serving BCCH carrier is below or above the threshold. The MS may use the search frames, which are not required for BSIC decoding, for these measurements. If indicated by the parameter 3G_SEARCH_PRIO, the MS may use up to 25 search frames per 13 seconds without considering the need for BSIC decoding in these frames.

If the serving cell is not included in the BA(SACCH)list, the dedicated channel is not on the BCCH carrier, and Qsearch_C is not equal to 15, the MS shall disregard the Qsearch_C parameter value and always search for cells belonging to other radio access technologies. If Qsearch_C is equal to 15, the MS shall never search for cells on other RAT.

The MS shall report a new best UTRAN cell, which is part of the neighbor cell list, at the latest 5 seconds after it has been activated under the condition that there is only one UTRAN frequency in the neighbor cell list and that no new GSM cells are activated at the same time, and under good radio conditions.

The allowed reporting time is increased by 5 seconds for each additional UTRAN frequency in the neighbor cell list and by the time required for BSIC decoding of new activated GSM cells. However, multiple UTRAN cells on the same frequency in the neighbor cell list does not increase the allowed reporting time.

When on a TCH, identification of a TDD cell is guaranteed only in the case of single slot operation and, for a 3.84 Mcps option, if the TDD cell uses synchronization option 2 (see 3GPP TS 25.221). In all other cases, the MS may not be able to fulfill the requirement above. If after 5 seconds the MS has not been able to identify a TDD cell, the MS is allowed to stop searching for it in the current GSM cell.

When on SDCCH, the MS may use all TDMA frames, which are not part of the assigned channel or that are required for GSM signal strength measurements, for the above task. In this case the allowed reporting time is 1.7 seconds, with the same assumptions as above.

A multi-RAT MS shall be able to monitor 64 cells from other radio access technologies, divided into (depending on the MS capability): FDD cells on up to 3 FDD frequencies, with a maximum of 32 cells per frequency; TDD cells on up to 3 TDD frequencies, with a maximum of 32 cells per frequency; and/or CDMA2000 cells.

As can be appreciated, this conventional inter-RAT approach does not address and solve the problems that were discussed above.

### Summary of the Exemplary Embodiments

The foregoing and other problems are overcome, and other advantages are realized, in accordance with the non-limiting and exemplary embodiments of this invention.

In accordance with one non-limiting aspect thereof the exemplary embodiments of this invention provide a method that comprises: determining in a wireless communication network a current communication requirement of a user equipment that is communicating using a first type of radio access technology; and instructing the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

In accordance with another non-limiting aspect thereof the exemplary embodiments of this invention provide a computer program product embodied on a tangible medium and comprising instructions that, when executed by at least one data processor, result in operations that comprise: determining in a wireless communication network a current communication requirement of a user equipment that is communicating using a first type of radio access technology; and instructing the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

In accordance with a further non-limiting aspect thereof the exemplary embodiments of this invention provide a wireless network node that comprises at least one functional unit adapted to determine a current communication requirement of a user equipment that is communicating using a first type of radio access technology. The at least one functional unit is further adapted to instruct the user equipment using downlink signaling to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

In accordance with still another non-limiting aspect thereof the exemplary embodiments of this invention provide a method that comprises operating a user equipment in a serving cell that supports a first radio access technology that accommodates a current communication requirement of the user equipment; receiving downlink signaling from a wireless communication network at-the user equipment, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement; and reporting using uplink signaling a measurement made of the serving cell and also at least one measurement made of the at least one neighbor cell that uses the type of radio access technology that would also accommodate the current communication requirement.

In accordance with another non-limiting aspect thereof the exemplary embodiments of this invention provide a computer program product embodied on a tangible medium and comprising instructions that, when executed by at least one data processor of a user equipment, result in operations that comprise: when the user equipment is operating in a serving cell that supports a radio access technology that accommodates a current communication requirement of the user equipment, receiving downlink signaling from a wireless communication network, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement; and reporting using uplink signaling a measurement made of the serving cell and also at least one measurement made of the at least one neighbor cell that uses the type of radio access technology that would also accommodate the current communication requirement.

In accordance with yet another non-limiting aspect thereof the exemplary embodiments of this invention provide a user equipment that includes at least one transceiver adapted for wireless communication, and that further comprises a control unit adapted to, when the user equipment is operating in a serving cell that supports a radio access technology that accommodates a current communication requirement of the user equipment, receive downlink signaling from a wireless communication network via the at least one transceiver. The signaling includes information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement. The control unit is further adapted to report, using uplink signaling via the at least one transceiver, a measurement made of the serving cell and also at least one measurement made of the at least one neighbor cell that uses the type of radio access technology that would also accommodate the current communication requirement.

### BRIEF DESCRIPTION OF THE DRAWINGS

The foregoing and other aspects of the teachings of this invention are made more evident in the following Detailed Description, when read in conjunction with the attached Drawing Figures, wherein:

FIG. 1 is a simplified block diagram of a wireless communication network and UE that are suitable for implementing the exemplary embodiments of this invention.

FIG. 2 is a block diagram showing in greater detail the packet scheduler and measurement report handling and control function, and the communication paths between them and with the UE, that are shown in FIG. 1.

FIG. 3 is a logic flow diagram that illustrates a method, and the operation of a computer program product, of a wireless network node, such as the Node-B shown in FIG. 1.

FIG. 4 is a logic flow diagram that illustrates a method, and the operation of a computer program product, of the UE shown in FIG. 1.

### DETAILED DESCRIPTION

As employed herein a 3.9G RAT is assumed to be one compatible with EUTRAN, also referred to as UTRAN-LTE, for which specification and standardization efforts are on-going. A 2G RAT may be, as non-limiting examples, compatible with GPRS/EDGE, GSM or PDC, while a 3G RAT may be one compatible with, as non-limiting examples, UMTS, WCDMA and cdma2000.

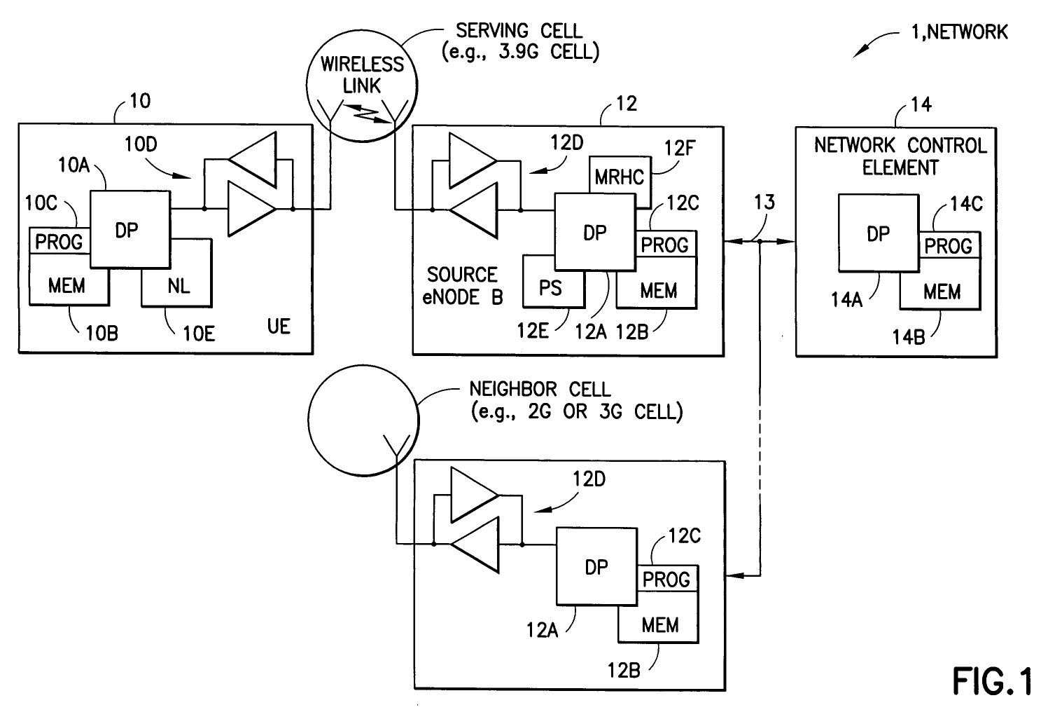

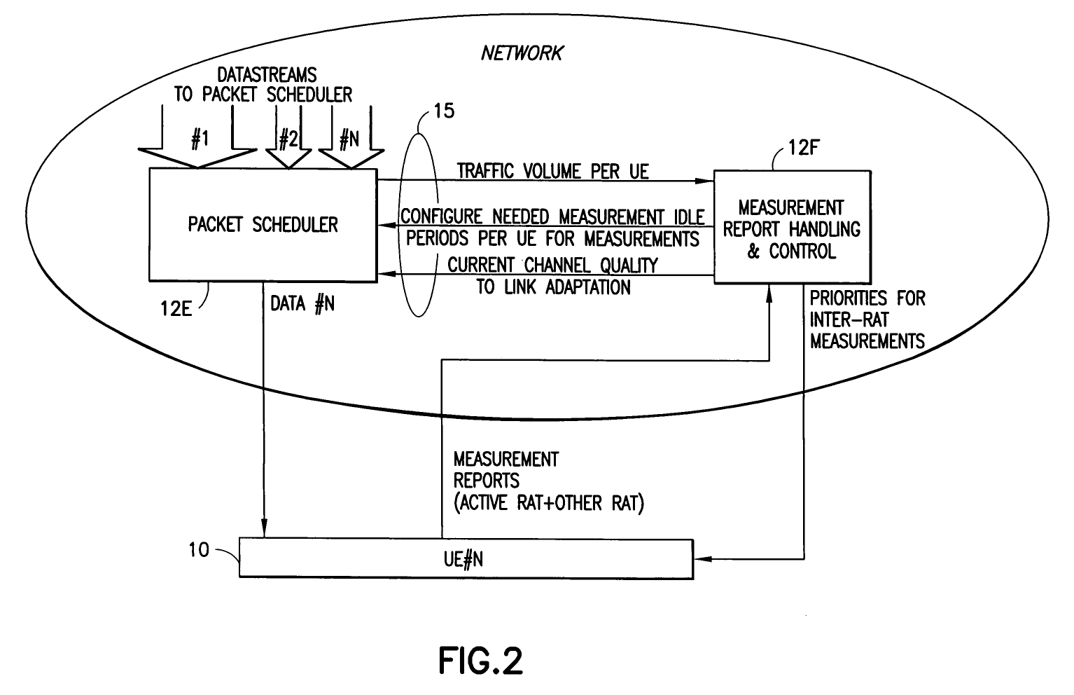

Reference is made first to FIG. 1 for illustrating a simplified block diagram of various electronic devices that are suitable for use in practicing the exemplary embodiments of this invention. In FIG. 1 a wireless network 1 is adapted for communication with a UE 10 via a Node-B (base station) 12. The network 1 may include, as part of a CN, a network control element (NCE) 14, which in an EUTRAN system may be an access gateway (aGW). The UE 10 includes a data processor (DP) 10A, a memory (MEM) 10B that stores a program (PROG) 10C, and at least one suitable wireless, e.g., radio frequency (RF) transceiver 10D for bidirectional wireless communications with the Node B 12, which also includes a DP 12A, a MEM 12B that stores a PROG 12C, and a suitable RF transceiver 12D. The Node-B 12 is shown as including a PS 12E, and may also include a MRHC function 12F (e.g., see FIG. 2). Note that the PS 12E and MRHC function 12F need not both be co-located within any one physical device or node of the network 1. The Node B 12 is coupled via a data path 13 to the NCE 14 that also includes a DP 14A and a MEM 14B storing an associated PROG 14C. At least one of the PROGs 10C, 12C and 14C is assumed to include program instructions that, when executed by the associated DP, enable the electronic device-to operate in accordance with the exemplary embodiments of this invention, as will be discussed below in greater detail.

Also shown is a second base station (BS) 12', which may also be a Node-B, and which may be considered to be a neighbor BS. The neighbor BS may be of a different RAT type, e.g., a BS associated with a 2G or a 3G RAT. Further, while only one BS 12′ is shown, typically there will be several that qualify at any given time as neighbor BSs. The BS 12′ also includes a DP 12A, MEM 12B, PROG 12C and wireless transceiver 12D. Note that while the BS 12′ may operate in accordance with a different RAT than the Node-B 12, it may also be connected to the same CN as the Node-B 12.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The exemplary embodiments of this invention may be implemented by computer software executable by the DP 10A of the UE 10, the DP 12A of the Node-B 12 and the other DPs, or by hardware, or by a combination of software and hardware.

The MEMs 10B, 12B and 14B may be of any type suitable to the local technical environment and may be implemented using any suitable data storage technology, such as semiconductor-based memory devices, magnetic memory devices and systems, optical memory devices and systems, fixed memory and removable memory. The DPs 10A, 12A and 14A may be of any type suitable to the local technical environment, and may include one or more of general purpose computers, special purpose computers, microprocessors, digital signal processors (DSPS) and processors based on a multi-core processor architecture, as non-limiting examples.

In a 3.9G system, and on the NW side, there exists the PS 12E that allocates UL/DL resources to the UE 10. As such, the NW knows the allocated resources per UE, and also the data rate per UE. In order to make inter-RAT measurements (e.g., a measurement of the BS 12′ when in the serving cell of the Node-B 12) the NW needs to also provide sufficient UL/DL idle periods for UE 10. However, the idle periods that are needed for inter-RAT measurements consume time that could be used for reception of actual user data.

In accordance with the exemplary embodiments of this invention the NW (e.g., the PS 12E in cooperation with the MRHC function 12F shown in FIG. 2) uses the allocation level to control and prioritize the inter-RAT measurements of the UE 10 so as to avoid making measurements and reporting RATs of lower or lesser priority than another RAT or RATS that currently have a higher priority (e.g., due to a current user data rate and/or other QoS requirement or, more generally, a current communication requirement of the UE 10). As a result, fewer idle periods are needed for inter-RAT measurement purposes. Alternatively, more accurate measurements may be made from a higher priority RAT if all the allocated “inter-RAT measurement” idle periods are used for measuring the higher priority RAT.

It can be noted that the data rate between the UE 10 and the NW can be set as a particular value, however the actual user data rate (the data rate actually experienced by the user) may be less when radio conditions are degraded (e.g., due to link adaptation). That is, as more robust coding is used, and more data redundancy is employed, the actual or effective user data rate can be somewhat less than a requested or a granted data rate. As such, as used herein a reference to “data rate” may be read as a reference to a “user data rate”, which may or may not be equal to a requested or granted data rate between the NW and the UE 10.

Referring to FIG. 2, the PS 12E receives a plurality of data streams for various UEs served by the Node-B 12. These data streams will be associated, typically, with different data rates depending on the nature of the underlying call/connection (e.g., a voice call versus streaming video). At least one of the data streams (e.g., #N) is provided to UE #N, or the UE 10 in this example. The PS 12E is in bidirectional communication with the MRHC function 12F via a communication path 15. This bidirectional communication includes information for informing the MRHC function 12F of the traffic volume per UE, information for instructing the PS 12E to configure needed measurement idle periods per UE for making measurements, and information for informing the PS 12E of the current channel quality for link adaptation purposes. The UE 10 informs the MRHC function 12F via UL measurement reports of the results of the measurements conducted for the active RAT and at least one other RAT, which are accomplished via DL signaling of priorities for inter-RAT measurements.

The exemplary embodiments are further described with regard two exemplary use cases.

Use Case 1:

Assume that the UE 10 is in an “active” connection in 3.9G via the Node-B 12 and is using a high data rate application. The NW has knowledge of this (via PS 12E data rates obtained from the traffic volume per UE information) and orders the UE 10 to perform only 3G measurements. The 3G measurements are thus prioritized over 2G measurements since the NW knows that if the UE 10 is handed off, the 2G NW could not provide the same (required) data rate to support the high data rate application. As a result, the UE 10 begins making and reporting only 3.9G (Active RAT) and 3G (Other RAT) measurement results to the NW (and not 2G measurements). Assume then that the UE 10 moves outside of the 3.9G coverage area. In this case the NW commands the UE 10 to change the RAT from 3.9G to 3G with an inter-RAT handover procedure (e.g., the UE 10 is handed off from the Node-B 12 to the BS 12′).

Use Case 2:

Assume that the UE 10 is using a low data rate connection in 3.9G (e.g., ordinary phone call). In this case the NW orders the UE 10 to perform only 2G inter-RAT measurements since the 2G RAT can well provide the same service. The UE 10 then begins reporting only 3.9G (Active RAT) and 2G (Other RAT) measurement results to the NW (and not 3G measurements). Assume then that the UE 10 moves outside the 3.9G coverage area or, alternatively, that the 3.9G cell load rises due to the presence of high data rate users. In either case the UE 10 is sent a HO command to the 2G RAT that was previously measured and reported.

It is assumed that the UE 10, in order to make inter-RAT measurements, is provided with at least one neighbor list (NL) 10E that lists surrounding 2G neighbor cell(s) and 3G neighbor cell(s). Note that separate neighbor lists may be provided for each type of RAT, or a single list may be provided that includes information for identifying the listed neighbor cells by RAT-type. The signaling to the UE 10 may comprise information for specifying one or more neighbor cell lists for use (each associated with a particular other type of RAT that would support the current UE 10 communication requirement), thereby excluding the UE 10 from measuring and reporting information from at least one other neighbor cell list associated with at least one neighbor cell operating in accordance with at least one additional type of RAT. Alternatively, the signaling may contain information that specifies those neighbor cells (or neighbor cell lists) for which measurements and reporting are not required.

It should be noted that while the preceding paragraph is generally applicable to current wireless systems, the exemplary embodiments of this invention are applicable also to systems that do not or would not utilize a “neighbor, list” and where, instead, the UE 10 generates a list of surrounding neighbors.

During an active 3.9G connection the PS 12E “keeps track” on the allocated UL/DL resources to the UE 10. Based on this information the MRHC 12F can prioritize the desired inter-RAT measurements. The priority can be indicated to the UE 10 via DL signaling. In response, the UE 10 need only measure and report the indicated high priority RAT(s), together with the 3.9G channel quality reports.

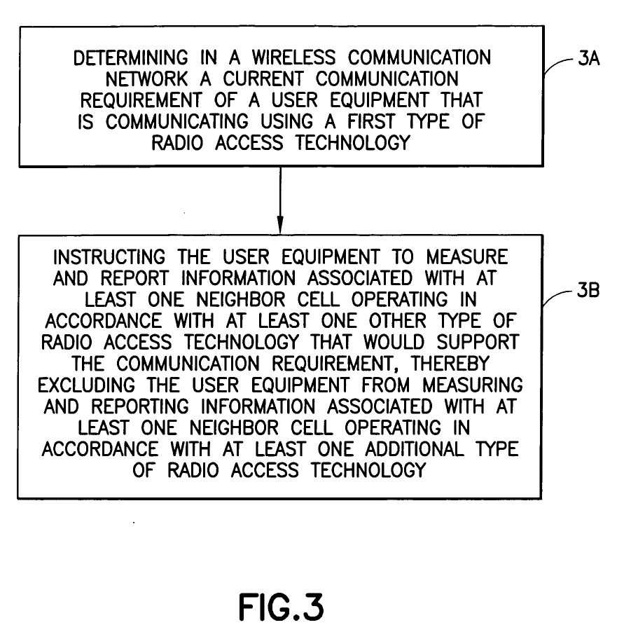

FIG. 3 is a logic flow diagram that illustrates a method, and the operation of a computer program product, of a wireless network node, such as the Node-B 12 shown in FIG. 1. A method includes (Block 3A) determining in a wireless communication network a current communication requirement of a user equipment that is communicating using a first type of radio access technology; and (Block 3B) instructing the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

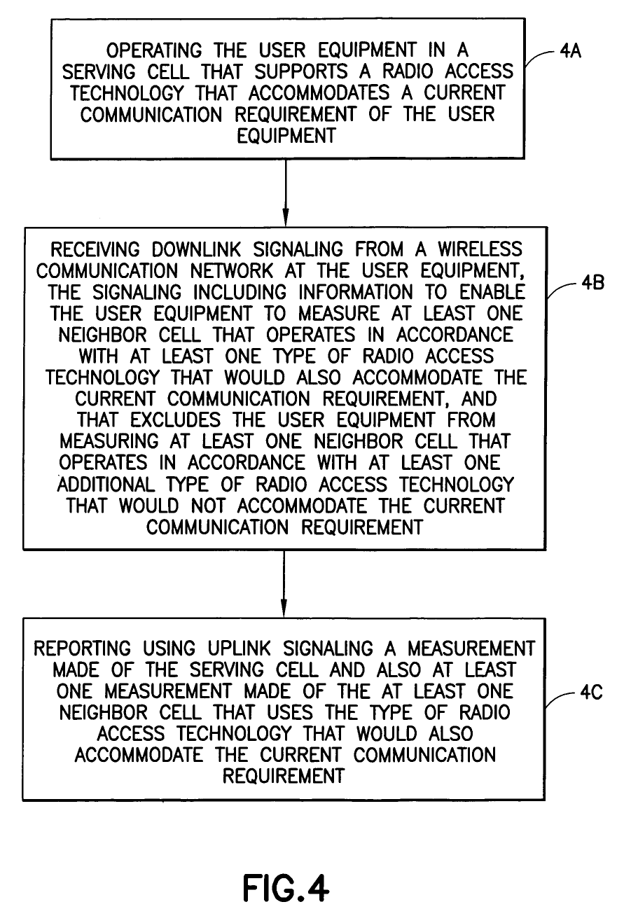

FIG. 4 is a logic flow diagram that illustrates a method, and the operation of a computer program product, of the user equipment 10 shown in FIG. 1. A method includes (Block 4A) operating the user equipment in a serving cell that supports a radio access technology that accommodates a current communication requirement of the user equipment, and (Block 4B) receiving downlink signaling from a wireless communication network at the user equipment, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement. The method further includes (Block 4C) reporting using uplink signaling a measurement made of the serving cell and also at least one measurement made of the at least one neighbor cell that uses the type of radio access technology that would also accommodate the current communication requirement.

It should be noted that the various blocks shown in FIGS. 3 and 4 may be viewed as method steps, and/or as operations that result from execution of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardwaie, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules. The design of integrated circuits is by and large a highly automated process. Complex and powerful software tools are available for converting a logic level design into a semiconductor circuit design ready to be fabricated on a semiconductor substrate. Such software tools can automatically route conductors and locate components on a semiconductor substrate using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility for fabrication as one or more integrated circuit devices.

Various modifications and adaptations may become apparent to those skilled in the relevant arts in view of the foregoing description, when read in conjunction with the accompanying drawings and the appended claims.

For example, while the exemplary embodiments have been described above in the context of a 3.9G RAT such as the EUTRAN (UTRAN-LTE) system, it should be appreciated that the exemplary embodiments of this invention are not limited for use with this one particular type of wireless communication system, and that they may be used to advantage in other wireless communication systems. Further, the exemplary embodiments of this invention can be used with 4G RATs and beyond.

Further, it should be noted that there may be a plurality of RAT-types that would currently support the UE 10 communication requirements, and the UE-10 in this case may be instructed to measure and report the Current RAT and a plurality of Other RATs, and thus not measure and report one or more Additional RAT types.

Further, while described generally in the context of a UE 10 having a single receiver (single transceiver), the exemplary embodiments of this invention may be used as well with those UEs that include a plurality of receivers/transceivers, such as those adapted for use in different frequency bands possibly using different modulation and coding schemes and different access technologies.

Furthermore still, some of the features of the examples of this invention may be used to advantage without the corresponding use of other features. As such, the foregoing description should be considered as merely illustrative of the principles, teachings, examples and exemplary embodiments of this invention, and not in limitation thereof.

What is claimed is:

1. A method, comprising:
determining in a wireless communication network a current communication requirement of a user equipment that is communicating using a first type of radio access technology; and
instructing the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

2. The method of claim 1, where the communication requirement comprises a data rate.

3. The method of claim 1, further comprising handing off the user equipment to a base station of a measured and reported neighbor cell.

4. The method of claim 1, further comprising receiving a report from the user equipment of a measurement associated with a current serving cell that uses the first type of radio access technology.

5. A computer program product embodied on a tangible medium and comprising instructions that, when executed by at least one data processor, result in operations that comprise:
determining in a wireless communication network a current communication requirement of a user equipment that is communicating using a first type of radio access technology; and
instructing the user equipment to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

6. The computer program product of claim 5, where the communication requirement comprises a data rate.

7. The computer program product of claim 5, further comprising an operation of handing off the user equipment to a base station of a measured and reported neighbor cell.

8. The computer program product of claim 5, further comprising an operation of receiving a report from the user equipment of a measurement associated with a current serving cell that uses the first type of radio access technology.

9. A wireless network node, comprising at least one functional unit adapted to determine a current communication requirement of a user equipment that is communicating using a first type of radio access technology; and further adapted to instruct the user equipment using downlink signaling to measure and report information associated with at least one neighbor cell operating in accordance with at least one other type of radio access technology that would support the communication requirement, thereby excluding the user equipment from measuring and reporting information associated with at least one neighbor cell operating in accordance with at least one additional type of radio access technology.

10. The wireless network node of claim 9, where the communication requirement comprises a data rate.

11. The wireless network node of claim 9, further adapted to instruct the user equipment to handoff to a base station of a measured and reported neighbor cell.

12. The wireless network node of claim 9, further adapted to via uplink signaling a report from the user equipment of a measurement associated with a current serving cell that uses the first type of radio access technology.

13. The wireless network node of claim 9, embodied at least in part in a base station.

14. The wireless network node of claim 9, embodied at least in part in a packet scheduler function.

15. The wireless network node of claim 9, embodied at least in part in a measurement report handling and control function.

16. The wireless network node of claim 9, embodied at least in part in a packet scheduler function and in a measurement report handling and control function, and further comprising a communication path between said packet scheduler function and said measurement report handling and control function whereby said packet scheduler function informs said measurement report handling and control function of a least a data rate requirement of said user equipment.

17. The wireless network node of claim 9, where the first radio access technology comprises EUTRAN, and where the at least one other type of radio access technology comprises at least one of a 2G and a 3G radio access technology.

18. The wireless network node of claim 9, where the first radio access technology comprises one of a 2G or 3G radio access technology, and where the at least one other type of radio access technology comprises the other one of the 2G or 3G radio access technology.

19. The wireless network node of claim 9, where the first radio access technology comprises at least one of a 2G and 3G radio access technology, and where the at least one other type of radio access technology comprises EUTRAN.

20. A method, comprising:
operating a user equipment in a serving cell that supports a first radio access technology that accommodates a current communication requirement of the user equipment;
receiving downlink signaling from a wireless communication network at the user equipment, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement; and
reporting using uplink signaling a measurement made of the serving cell and also at least one measurement made of the at least one neighbor cell that uses the first type of radio access technology that would also accommodate the current communication requirement.

21. The method of claim 20, where the current communication requirement comprises a data rate.

22. The method of claim 20, further comprising handing off the user equipment to a base station of a measured and reported neighbor cell.

23. A computer program product embodied on a tangible medium and comprising instructions that, when executed by at least one data processor of a user equipment, result in operations that comprise:
when the user equipment is operating in a serving cell that supports a radio access technology that accommodates a current communication requirement of the user equipment, receiving downlink signaling from a wireless communication network, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement; and
reporting using uplink signaling a measurement made of the serving cell and also at least one measurement made of the at least one neighbor cell that uses the type of radio access technology that would also accommodate the current communication requirement.

24. The computer program product of claim 23, where the current communication requirement comprises a data rate.

25. The computer program product of claim 23, further comprising an operation of handing off the user equipment to a base station of a measured and reported neighbor cell.

26. A user equipment, comprising at least one transceiver adapted for wireless communication, further comprising a control unit adapted to, when the user equipment is operating in a serving cell that supports a radio access technology that accommodates a current communication requirement of the user equipment, receive downlink signaling from a wireless communication network via said at least one transceiver, the signaling including information to enable the user equipment to measure at least one neighbor cell that operates in accordance with at least one type of radio access technology that would also accommodate the current communication requirement, and that excludes the user equipment from measuring at least one neighbor cell that operates in accordance with at least one additional type of radio access technology that would not accommodate the current communication requirement; said control unit further adapted to report, using uplink signaling via said at least one transceiver, a measurement made of the serving cell and also at least one measurement made of the at least one neighbor cell that uses the type of radio access technology that would also accommodate the current communication requirement.

27. The user equipment of claim 26, where the current communication requirement comprises a data rate.

28. The user equipment of claim 26, said control unit further adapted to hand off the user equipment to a base station of a measured and reported neighbor cell.
